(19) United States
(12) Patent Application Publication
(10) Pub. No.: US 2003/0116627 A1
(43) Pub. Date: Jun. 26, 2003

(54) Method for integrating hidden information in a set of notes

(76) Inventors: Stephen Wolthusen, Burstadt (DE); Christoph Busch, Darmstadt (DE); Ero Rademer, Ramstadt (DE)

Correspondence Address: VENABLE, BAETJER, HOWARD AND CIVILETTI, LLP, P.O. BOX 34385, WASHINGTON, DC, 20043-9998, US

(21) Appl. No.: 10/276,064

(22) PCT Filed: Apr. 4, 2001
(86) PCT No.: PCT/DE01/01333

(30) Foreign Application Priority Data
May 15, 2000 (DE) 100 23 759.2

(51) Int. Cl. G06K 7/10; G06K 7/14; G06K 19/06

(52) U.S. Cl. 235/454; 235/494

(57) ABSTRACT

The present invention relates to a method for integrating hidden information in a set of notes. In this method, the geometric shape of the geometric elements of the set of notes and/or their geometric relationship to each other are modified compared to the original version according to a predetermined key in such a manner that the modifications bear the to-be-integrated information in digital form and legibility of the set of notes is not impaired.

In particular, the method permits integrating a marking in a set of notes that is not lost by copying or simple manipulation of the set of notes.

### TECHNICAL FIELD

The present invention relates to a method for integrating hidden information in a set of notes and a respective method for reading out this information. The main field of application of the present invention is the protection of the work of a set of notes of classical or contemporary music in circulation in paper form or even in common electronic representations, such as for example PDF or graphic files. In making a work accessible to the public, it is important for the author or publisher of a set of notes respectively of a score that if a work is copied or even, if required, manipulated that the copies always indicate the author respectively the copyright holder. The present invention provides a suited method therefor.

### STATE OF THE ART

The methods presently available to publishers to protect the work of a set of notes usually comprises using a paper support visibly bearing an especially applied watermark or applying certain ornaments, decoration or written indication of copyright along with the set of notes onto the paper support.

These methods, however, are not suited for protecting rights (copyright) or for detecting illegal copies. For example, when copying a paper document or a part thereof, the watermark of the original is not longer detectable in the copy. Ornaments, decoration or written indication of a copyright can be removed by simple means in such a copying process. Thus with such manipulated copies it is impossible to prove that they are a copyright-protected copy of an original of the respective publishing house. It is no longer or not easily possible to trace the origin of the work.

Based on this state of the art, the object of the present invention is to provide a method of integrating hidden information in a set of notes that prevents removal of this information or at least makes removal quite difficult when copying the set of notes. Furthermore, the present invention should also provide a method for extracting the hidden information integrated in the set of notes.

### DESCRIPTION OF THE INVENTION

The object is solved using the method of claim 1 respectively 21. Advantageous embodiments of the methods are the subject matter of the subclaims. Claim 20 describes a device for carrying out the method of claim 1.

In the invented method, a sort of digital watermark that is not visible to the normal reader of the set of notes is integrated in the set of notes.

In the method, the geometric shape and/or the mutual geometric proportions of some of the geometrical elements of the set of notes, such as base lines, bars, stems of notes and heads of notes are modified relatively to an unmarked representation (the original respectively the original representation) according to a predetermined key in such a manner that the modifications bear the to-be-integrated information in digital form and do not diminish the legibility of the set of notes. The set of notes modified in this manner is then put in the circulation form of the representation, i.e. printed on a paper support or transferred into a corresponding electronic representation, for example a graphic file or a PDF file and stored.

The digital watermark integrated in the set of note respectively the score is also copied in this manner when making paper photocopies and cannot be removed by partly cutting the copy, scaling, shearing or filtering (e.g. blurring) without impairing the quality of the representation to such an extent that it is only possible to use of the copied score to a limited extent. The score subjected to the invented method may be printed on paper as well as may be suitably duplicated electronically. Unlawful copies can be assigned unequivocally to the issuer of the original by the digital watermark still borne by them. The advantageous properties of a digital watermark are its robustness against manipulation attempts, with it being very difficult or even impossible to remove the watermark without evident loss of quality of the original. Modification of the original which only slightly impairs quality does not harm the digital watermark. The possibility of hidden integration of the digital watermark makes it invisible to most readers but still legible to correspondingly authorized persons.

Use of digital watermarks is known for the protection of other kinds of models. As a prerequisite, these models, however, must contain a certain measure of noise, such as for example music or images, in order to be able to apply the prior art digital watermark method to them. The desired information is then integrated in this noise in a concealed manner and can be read again later. Such a type of method can, for example, be applied to a scanned-in image of a set of notes, because it contains background noise. However, protection of the correspondingly scanned-in document is only ensured as an image document. Due to the resulting size of the file or the diminishment of quality when using small files, such types of representation can only be employed to a very limited degree. A representation, which also ensures protection in analog representation (print outs or screen graphics) suited for electronic transfer, is only possible by encryption in a semantic representation. The present method according to the valid claim 1 ensures this protection for the first.

The present protection mechanism relates primarily to sets of notes per se and not to the protection of the music conveyed with these notes. It is apparent that other representations can be created from the set piece of music, in that the semantic information of the set of notes is decrypted and the piece is reset. The present method can, of course, not protect against such type further processing. In most cases, however, this is of secondary significance, because the semantic information, that is the music itself, continues to be legally protected material within the limits set by the copyright.

Some applications of the present method of integrating hidden information respectively a digital watermark can serve copyright protection of the set of notes including integrating hidden comments and information regarding the authenticity of the data of the set of notes or the authenticity of the document itself.

Fundamentally, the predetermined key for integrating the information is based on two alternative methods. One method requires the unmarked original respectively the original representation for reading out; the second method permits reading out the integrated information without the aid of the original. In the former method, the information is integrated in a relative modification of the form or arrangement respectively a different geometric dimensions of the selected geometric element compared to the original. In the latter method, this information is integrated in the set of notes by modifying the geometric shape or the geometric proportions of some geometric elements of a group of elements. The comparison required for reading out occurs in the second method by using the remaining geometric elements of the respective group. The original is not required for this.

The modifications are made in such a manner that the legibility of the set of notes is not impaired. In other words the lay or professional musician using the set of notes has no difficulty reading the set of notes. Preferably, however the modifications are so minor that the reader of the set of notes reading the notes without knowing that digital information may have been integrated in the set of notes will not perceive the modifications.

The present method can use various geometric shapes contained in the set of notes. An incomplete list of possible geometric elements of the set of notes that may be utilized is given in the following without the intention of conveying that the order of sequencing represents the ranking order for using these geometric elements. Especially advantageous is if the present method for integrating the information occurs in conjunction with the respective reading out method for straight lines and angles respectively a modification of the spaces between the straight lines or between the angles of the corresponding element. For example, the following geometric elements of the set of notes are suited for the present method:

the vertical space between the base lines of a system of notation;

the horizontal space between the bar lines;

the vertical space between the systems of notation;

the angle of the stems of the notes to the base lines of the notes deviating from the vertical;

the horizontal space between the heads of the notes;

the angle of the heads of the notes of a chord deviating from the vertical;

the position of the dot of dotted notes respectively in staccati with regard to the angle to the center of the note and/or to the distance to the head of the note;

the position of accents (staccati, flageolet, pauses, stresses, etc.);

the angle of the strokes of the note relative to the base lines;

the thickness of the stroke of the note;

the thickness (in the center) of legato arcs;

the thickness (in the center) of connecting arcs;

the thickness of double bar lines;

the thickness of final bar lines;

the thickness of repeat signs;

the opening angle of crescendi/decrescendi signs;

the vertical space between ornaments (trills, fermata, etc.);

the relative length of short (half) note stems with hooks (⅛ or 1/16);

the relative angle of ¼ and ⅛ rest signs;

the length of additional lines; or

the length of stems of notes, as long as the modification is constant for an entire bar.

Some of the examples of modification of the geometric elements are described in the preferred embodiments.

The selection of the elements of the set of notes suited for integrating the respective information depends on the amount of information and on the set of notes itself. In order to ensure that as much information as possible can be embedded, an algorithm, which has an expedient manner of proceeding, can also be employed for the analysis of the score data. The analysis should be based on one part of the system of notation. This is necessary in order to ensure the robustness of the embedded information against being cut off. A part is the smallest unit into which a certain amount of information can be integrated without making this modification too strong or even disturbingly visible. A major portion of the information can be integrated in these single parts. The information can, of course, also be embedded in elements that are employed for embedding multiple parts (system of notation, such as for example their spacing.

An expedient manner of proceeding in this case means that, depending on the respective music, not all the integration elements are present in a part so that the analysis identifies those elements that are present in the given starting material and selects the suited integration elements therefrom. All the present elements respectively elements listed at the start can be used randomly. An example of this is only the angle of a stem of a note to the vertical, which can bear, depending on the predetermined key either, only one bit of information or—by means of different distinguishable angle positions—also multiple bits of information.

Integrating the information as a digital watermark can occur in two embodiment variants. On the one hand, a public watermark can be employed which contains, in particular, copyright information. It is intended to be read by someone who possesses the corresponding reading out technology. The second embodiment variant is using a secret watermark. In this case, the embedded information can only be read if the reader possesses a special key.

Basically the embedding of the watermark should not occur in fixed elements or positions in the set of notes. But rather, the type and position of the integration should be document specific and/or key specific. Depending on whether the embedded information should be made accessible to third parties, the key can be given to third parties or fundamentally published.

The type of integration depends on whether or not the original is available when reading out. If the original is available when reading out, the single elements of the document can be modified from the original and reread by comparing with the original. If the original is not available, the amount of integratable information is less. In this case, different to-be-varied elements in the group are selected. The marking is then integrated by modifying the proportions of the elements to each other. Relevant for reading out are the features of the elements of the group deviating from the group characteristics.

Dependent on the desired robustness against transformations and the maximum tolerated degree of visible modifications, each geometric element can take up one or multiple bits of to-be-integrated information. The embedding function respectively the predetermined key can distribute this information over all the elements in the document. The distribution can, for example, occur over a random number generator (PRNG), for the initialization of which an own secret key is used. Furthermore, it is, of course, also possible to encrypt the to-be-integrated information using a suited key. It is expedient to use a different key than the one for initialization of the random number generator.

As there is a possibility that single elements cannot be completely extracted from the document, such as for example due to stains on a photocopy, error-correcting codes such as BCH (Bose-Chaudhuri-Hochquenghem) are used if more than just the presence of one marking is supposed to be detected.

However, if only the presence of one marking in a set of notes is supposed to be detected, it suffices to integrate a fixed bit pattern in the document. Reading out the data occurs then by means of a simple hypothesis test in which testing is only for only the presence of modifications. In this case, the use of error-correcting codes is, of course, not required.

Depending on the respective field of application, the present bandwidth of the information-bearing signal can be utilized differently. A single code is suited predominantly for long information. Even if the use of error-correcting codes is helpful in detecting the watermark if there are few errors, in the case of a single code the information is destroyed if the document is trimmed a lot. If significance is placed predominantly on the robustness of the watermark, multiple copies should be implemented. This multiple integration of the same information protects the document better against error or trimming. Even if a copy of this information is destroyed by trimming the document, there is a greater possibility of being able to read another almost intact copy. If the bandwidth is too great for the information-bearing signal, multiple different watermarks (multiple watermarks) can be embedded overlappingly with different keys. The bandwidth of the information-bearing signal depends on the number of suited geometric elements of the set of notes that are available for integrating the information.

A suited device for carrying out the present method comprises means of reading in or entering a set of notes, which is composed, for example, of a scanner or a corresponding direct input unit for the set of notes, of a device for the geometric analysis of the set of notes for suited elements for integrating the information in the set of notes and for integrating the information in the set of notes by modifying the suited geometric elements or the geometric elements selected therefrom according to a predetermined key. Modification is carried out by changing the geometric shape and/or the mutual geometric proportions compared to the read in or entered representation. Furthermore, means are provided for the output of the set of notes provided correspondingly with the information. This means can, for example, be in the form of a printer having a resolution of at least 300 dpi or even in the form of a unit for providing a corresponding electronic format of the set of notes.

The method of reading out the information, which will be described in great detail in the following preferred embodiment, detects the geometric elements of the set of notes and compares their geometric shape and/or their geometric proportions or with the original set of notes in order to detect the information from theses modifications according to a predetermined key. Preferably, the entire evaluation is conducted on the basis of a screen image of the set of notes which, if required, is generated from a copy present in paper form or from a copy of the set of notes present in different electronic representation.

The invented method is made more apparent in the following using preferred embodiments with reference to the accompanying drawings.

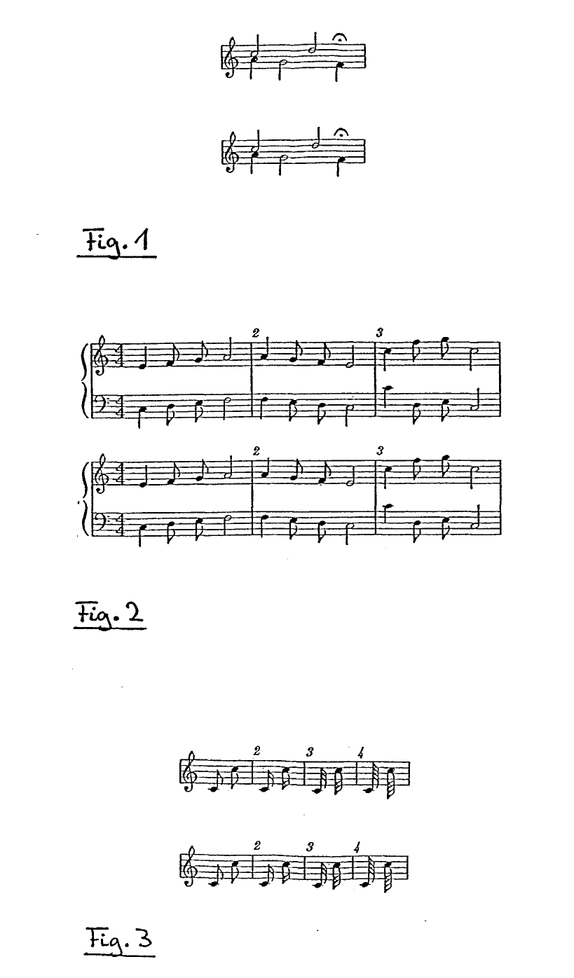

FIG. 1 shows a first example of a modification of the geometric elements of a set of notes (detail) using the present method;

FIG. 2 shows a second example of a modification of the geometric elements of a set of notes (detail) using the present method; and

FIG. 3 shows a third example of a modification of the geometric elements of a set of notes (detail) using the present method.

### WAYS TO CARRY OUT THE INVENTION

The figures show modifications of the geometric representation of a set of notes with which hidden information is integrated in the set of notes. Of course, these are only simple examples for illustrating the method from which someone skilled in the art, however, can recognize the effect and the overall concept of the present invention very well.

FIG. 1 shows in the top section the original, in the bottom section the same sequence with geometric elements modified according to the present method. In the present example, the spaces between the notes have been modified in order to integrate the information. Thus the space between the notes g and d′ is slightly increased compared to the original, the space between d′ and f is decreased accordingly. The width of the entire sequence remains unchanged.

In FIG. 2, in which the original is once more shown in the top part and the version marked according to the present method is shown in the bottom part, the length of the stems of the notes was modified in order to integrate the information. Altering the length of the note stems should occur only in one bar. In the depicted piano piece, the length of the stems of the notes changes in the right hand only in the middle bar, in the left hand they change for single notes.

Finally FIG. 3 shows in the same manner a sequence of several bars, in the top the original, in the bottom the modified version. In this example, the position of the bar line of bar 4 is slightly modified together with the spaces between the notes in bar 3. Reading flow is practically undisturbed and the overall width of the section is the same as in the original.

From the depicted simple examples, it is easy to see that the integrated information is not obvious. Even the presence of additional integrated information is not obvious for a professional musician without having it pointed out.

The manner of proceeding in integrating and reading out the information is described once more in the following using a general example. The single steps of this example are, of course, exemplary, and can be utilized in other suited embodiments for carrying out the present invention.

After analysis of the respective score respectively the geometric elements of this score, for example, the following elements respectively geometric properties of the elements are considered for integration of the information:

the angle of the stems of the notes to the base lines;

the horizontal space between the notes;

the angle of the stems with hooks of the notes relative to the base lines; and

the spaces between the bars within a part.

These elements should be present and easy to extract in most scores. If these geometric properties have been modified, a high degree of detection is possible by comparison with the original even if the changes are minor.

Based on such a list of embedded elements, a pseudo-random number generator (PRNG), initialized with an embedding key—can be used for selecting the elements which should be utilized for integrating the wanted information. A prerequisite is that there is a sufficiently large number of suited elements available for selection. The start value of the PRNG is then a part of the reading out key. In this case, the allocation of integration elements to information bits must be random but for integration and reading out it must be the same.

The selection of the pseudo-random number generator depends primarily on computational output that can be or should be provided therefor. Suited pseudo-random number generators are Blum, Blum and Schub's algorithms (A Simple Unpredictable Pseudo-Random Number Generator”, Siam J. Comput., vol. 15, 364-383 (1987) and Kelsey, Schneider and Ferguson's “Yarrow” (Sixth Annual Workshop on Selected Areas in Cryptography”, Springer Verlag 1999).

The integrated information has to be encrypted for secret watermarks, because the basic method for integrating watermarks is considered public knowledge. Encrypting is not required for public watermarks.

Following this, the to-be-integrated wanted information is provided with an error-correcting code. The to-be-integrated data are divided into small units depending on how many bits of information an integration element can take up. In the simplest and most robust case, this is one bit of information per element. Other than that, by means of the selection of different modification parameters such as different angles or spaces, multiple bits can be encrypted in one element.

If errors occur in reading out, for example due to disturbances during watermark detection, the error-correcting code enables one to retrieve the information nonetheless even if some elements cannot be recognized completely correctly or if they are totally missing. If the latter occurs too often, the Reed-Solomon code is preferably selected as the error-correcting code, because it is able to deal with such types of interruptions in a stream of code.

In the set of notes, in which the integration is not based on single elements but rather on groups of elements, the error-correcting code is an additional redundancy element that supports reading out. Thus an element can be read out even if parts of it have become illegible (e.g. by stains, etc.).

In the top quality grade, the watermark integrated in the printed score should not be perceivable to professional musicians. In lesser quality, it should not be perceived as disturbing when reading the score. A print resolution of 300 dpi is sufficient for using this method.

The watermark respectively the modifications of the elements of the set of notes bearing it should be selected in such a manner that they are still legible after the following processing steps:

After a D/A transformation followed by an A/D transformation, for example in the event of an attacker, who wants to photocopy the score or scan it in and then print it out. In this case, the to-be-tested copy must be subjected to an additional A/D transformation in order to read the watermark.

Disturbances caused by photocopying, for example stains or dots.

After filtering, for example adding blurring.

After scaling (altering the dimensions).

After a turn.

After trimming, tolerable should be up to 25% trimming.

After adding noise (in screen images).

The watermark should fundamentally be robust against manipulation to the extent that the score becomes illegible due to the manipulations (usually after 10-fold photocopying).

It should be more expensive to remove the watermark than to legally acquire the product.

All the above mentioned requirements can be satisfied without difficulty when applying the present method as intended.

The following information is preferably integrated as a digital watermark in the set of notes: an “owner code” that identifies the owner and copyright holder of the set of notes; a “musical area code” that defines the category of music and is assigned to the owner code; a “service provider code” that defines the publisher or the distributor; the date of publication of the set of notes (“release date”); the title of the piece of music (“title”); and the composer of the piece (“composer”). The following bit lengths are proposed for the individual elements of the watermark:

| Name | Number of bits | Value range |
|---|---|---|
| Start mark | 4 | — |
| CRC mark | 6 | — |
| Owner code | 10 | 0-1023 |
| Music area code | 17 | 0-131071 |
| Service provider | 13 | 0-8191 |
| Release date code | 11 | 0-170 |
| CRC mark | 6 | — |
| End mark | 4 | — |

The sole requirement for the content of the watermark is, however, that the single watermarks can be clearly identified; further information can be realized by linking to an external database.

Retrieving the watermark from the set of notes can occur in various scenarios, of which three are outlined below:

1. The document is in an electronic page description language such as Adobe® PostScript® or Adobe® PDF.

2. The document is in paper form and must be scanned in or has undergone corresponding modification.

3. The document is in electronic screen format, for example TIFF or JPEG/JFIF.

A single method can cover all these scenarios if this method works on screen images, because the scenarios in points 1 and 2 can easily be imaged on scenario 3. Moreover, scenario 2 requires an additional step in order to reverse possible affine transformations or offset, because the reading out mechanism is based on the geometric properties of the document.

Scenario 3 requires a method for extracting the single elements of the score in order to be able to read the watermark. These elements are base lines and shapes as well as their position in the system of notation. It is no problem if the quality of the screen images is inferior to the quality of the original (e.g., due to scanning).

Extraction of the watermark is greatly simplified if the original is available for comparison. In this case, the to-be-examined document is modified until it geometrically corresponds to the original as closely as possible. Typical modifications are scaling, cutting off parts, turning or shearing.

The most common type of notating music is using notation systems with five lines. However, this is not always the case. For example, Gregorian music is notated using four lines and the shapes of the heads are different. Percussion parts can be notated with one, two or three lines and also using different heads. Guitar fingering is depicted as a system with six lines. Early baroque music uses systems with more than five lines.

In any event, however the base lines are the largest number of parallel horizontal lines. For this reason, it suffices to use these lines to restore the orientation of the document in question. In the following, these elements are referred to as horizontal lines. Note stems, bar lines etc. are referred to as vertical lines.

In the usual system of notation, the stems of the notes, bar lines, etc. are placed perpendicular to the base lines. Certain transformations can result in that these nominally perpendicular lines stand in at another angle to each other than 90°. As both the embedding mechanism and non-affine transformations may influence the angle of the note stems, the algorithm for recognizing the vertical lines must also regard lines having an angle deviating from 90° as vertical.

The following steps depend on whether or not the original is available for comparison. In a simple case, if the original is available, the to-be-tested document only has to be scaled until the differences to the original are minimized. This can occur in that the line recognition algorithm is applied to the original and further comparison works on these line data. Subsequent detection of the embedded elements can simply occur by comparison with the original.

If the original is not available, the detection process is more difficult and requires that the wanted data be entered as relationships of single elements. In this case, scaling to the size of the original is not necessary because the proportions of the elements (positions in relation to each other, angles or thickness) are independent of absolute scaling.

For extraction of the embedded elements, it is advantageous to use a so-called Hough transformation.

In the event that the to-be-examined document has undergone a A/D conversion, a threshold value process has to be applied in order to turn the image into a real two-color image, because the local operators for subsequent edge detection react very strongly to changes in intensity.

Independent of what the source of the document is, it has to undergo an edge detection process prior to application of Hough transformation—for example Robert, Sobel or Canny edge detection (cf. Canny, F. J. A., IEEE Trans PAMi 8, 6 (1986), 679-698), morphological operators. Following this, thinning is conducted in such a manner that the lines are only precisely as thick as a pixel. This increases the precision of the subsequent transformation and reduces the necessary computation.

As the a simple Hough transformation can only extract lines and other simple shapes, such lines, with the exception of the base lines, have to also be segmented. In the following case of application, there is no need to be able to detect composite components.

A Hough transformation is described in detail in the scientific literature and is familiar to someone skilled in the art. It can be considered as a general process for recognizing patterns present as templates and is usually used to extract edges or curves from images. A Hough transformation may, however, also be employed to detect circles or generally predetermined shapes.

The fundamental idea behind it is to parameterize the equation of the curve. Although it can also be applied to greater dimensions, the typical case is a two-dimensional pattern, e.g. straight section, the center of circles or parabolas y=ax2+bx+c for a constant c.

Detection of a straight line in an image can be used as an example. This line is parameterized in the form ρ=x cos θ+y sin θ, with ρ being the distance perpendicular to the origin and θ being the angle to the normals. Colinear points (xi, yi) with i=1, . . . , N are transformed into N sinusoidal curves ρ=xi cos θ+yi sin θ of the (ρ, θ) plane, which intersect at point (ρ, θ).

One must be careful in the selection of the parameter range for (ρ, θ). If the disjunctive ranges (ρ, θ) are too finely distributed (the transformation can be represented as a two-dimensional histogram) each point of intersection of two sinus curves could land in a different range. On the other hand, if quantification is not fine enough, almost parallel adjacent lines will land in the same range.

For a certain range of quantificated parameters ρ and θ, each point (xi, yi) is imaged in the range (ρ, θ) and the points which belong to the sites (ρm, θm) are cumulated to a two-dimensional histogram H(ρm, θm), i.e., H(ρm, θm)=H (ρm, θm)+1.

If a gray-scale image g(x, y) is given and gi stands for the gray-scale value of the point (xi, yi), the gray-scale values are cumulated: H(ρm, θm)=H(ρm, θm)+gi. In this form, the Hough transformation essentially does not differ from a discrete Radon transformation which is usually employed to reconstruct three-dimensional objects from two-dimensional objects.

Local maxima of the pixel intensity H(ρm, θm) serve to identify straight line segments in the original image. A Hough transformation is invariant to rotation or translation.

Ideally, the range of a Hough transformation definition is only searched once for a maximum. In cases where the document contains many patterns of different sizes, it may be necessary in some circumstances to first remove distinctly to-be-identified patterns in the histogram from the image and then repeat the process.

If a threshold value formation is required, the following relationships must be noted. If F(i, j) is the original gray-scale image; if B(i, j) is a binary pixel representation (pixels either have the value 0 or 1) generated from F by threshold value formation: B(i, j)=1, if F(i, j)<t, B(i, j) 0, if F(i, j)≧t. All threshold processes operate in that they first generate a histogram over the entire image. Differentiating between the two values may occur manually or automatically. In the event of a triangle threshold value process, a straight line is constructed between the maximum in the histogram at a brightness of bmax and the lowest value of bmin. The distance d between the straight line and the histogram value h[b] is then calculated over all the values for b from b=bmin to b bmax. For the site at which the distance between h[b0] and the straight line is maximum, the brightness value b0 is the threshold value t. This method is especially advantageous if the object pixels generate single peaks in the histogram.

A Reed-Solomon code offers particular advantages if error-correcting codes are employed. Reed-Solomon codes are block-based error-correcting codes with a great variety of applications in the field of digital communication and storage. Reed-Solomon codes are a subset of BCH codes and are linear block codes. A Reed-Solomon code is specified by RS(n, k) using s-bit symbols. This means that the encrypter adds parity symbols to complete k data symbols of s bits and generates therefrom a n-bit codeword. Thus, there are n−k parity symbols each of s-bit length. A Reed-Solomon decrypter can now correct up to t erroneous symbols, with 2t=n−k. Reed-Solomon codes are especially suited to correct burst errors. These are errors in which several bits in a row are incorrect in a codeword.

The greatest difficulty in implementing Reed-Solomon codes is that conventional processors are unable to do Galois field arithmetic. For example, implementation of Galois field multiplication requires a test for zero, two table-look-ups, modulo addition and additional reverse table-look-ups.

Further details on error-correcting and Reed-Solomon codes can be found in respective scientific journals (e.g. Clark, Jr., G. C. et al., “Error-Correction Coding for Digital Communications”, Plenum Press, N.Y., USA 1981).

In contrast to the prior art methods of copyright protection of score data, the presented method is especially suited for application for data in electronic form. Reliable protection against copyright infringement is urgently required particularly with the increasingly growing commerce via the internet. The watermark integrated using the present method is difficult to remove. It can be stored encrypted in such a manner that the attacker familiar with the embedded method is unable to remove the watermark. Rendering the watermark unrecognizable is always accompanied by considerable loss of quality, whereas the digital watermark does not disturb authorized users of the documents.

What is claimed is:

1. A method for integrating hidden information in a set of notes composed of a multiplicity of geometric elements in which the geometric shape of some of said geometric elements of said set of notes and/or their mutual geometric relationship compared to the original representation are modified according to a predetermined key in such a manner that said modifications bear the to-be-integrated information in digital representation and do not impair the legibility of said set of notes.

2. A method according to claim 1,
wherein said modifications are selected in such a manner that said modifications are so minor that a reader of said set of notes does not perceive said modifications at first glance.

3. A method according to claim 1 or 2,
wherein the vertical or horizontal space between single elements of said set of notes is modified.

4. A method according to claim 3,
wherein said vertical space between the base lines of one or multiple systems of notation of said set of notes is modified.

5. A method according to claim 3 or 4,
wherein said horizontal space between the bar lines of said set of notes is modified.

6. A method according to one of the claims 3 to 5,
wherein said vertical space between said systems of notation of said set of notes is modified.

7. A method according to one of the claims 3 to 6,
wherein the horizontal space between the note heads and/or of the note stems of the set of notes is modified.

8. A method according to one of the claims 1 to 7,
wherein the angle of said note stems in relation to said base lines of said set of notes is modified.

9. A method according to one of the claims 1 to 8,
wherein the length of said note stems is modified.

10. A method according to one of the claims 1 to 9,
wherein the thickness of single elements of said set of notes is modified.

11. A method according to one of the claims 1 to 10,
wherein said predetermined key is a secret key.

12. A method according to one of the claims 1 to 11,
wherein said information is integrated in the modifications of single elements compared to the elements of the original representation of said set of notes.

13. A method according to one of the claims 1 to 11,
wherein said information is integrated in the modifications of mutual proportions, in particular of the space or angle, of single elements of a group of elements of said set of notes.

14. A method according to one of the claims 1 to 13,
wherein error-correcting codes are integrated along with the information.

15. A method according to one of the claims 1 to 14,
wherein first said set of notes to be provided with information is analyzed always based on one part of the system of notation contained in said set of notes with the geometric elements suited for the subsequent integration of information being selected in said analysis.

16. A method according to claim 15,
wherein said analysis is conducted via an optical pattern-recognizing process.

17. A method according to one of the claims 1 to 16,
wherein said information is distributed on the geometric elements suited for said integration of information by using a pseudo-random number generator.

18. A method according to one of the claims 1 to 17,
wherein said information is encrypted prior to integration.

19. A method according to one of the claims 1 to 18,
wherein the owner's name said set of notes or the copyright holder of said set of notes is integrated as said information.

20. A device for carrying out the method according to one of the preceding claims having
a means to read in or to integrate a set of notes,
a unit for said geometric analysis of said set of notes for suited geometric elements for integrating said information and for integrating said predetermined information in said set of notes by modifying according to a predetermined key the geometric shape of some of said suited geometric elements and/or their mutual geometric relationship compared to the read in or entered representation, and
a means for the output of said set of notes provided with said information.

21. A method for reading out said information integrated in said set of notes using said preceding method, in which said geometric elements of said set of notes are detected and said information is determined by comparing said geometric elements with the original set of notes or by comparing the single elements with each other according to said predetermined key based on deviations in said geometric shape and/or in said mutual geometric relationship.

22. A method according to claim 21,
wherein said set of notes is present as a screen image prior to detection of said geometric elements or is converted into a screen image form.

23. A method according to claim 21 or 22,
wherein said geometric elements of said set of notes are detected using a Hough transformation.
